(19) United States
(12) Patent Application Publication
(10) Pub. No.: US 2016/0026519 A1
(43) Pub. Date: Jan. 28, 2016

(54) Application Compatibility Leveraging Successful Resolution of Issues

(71) Applicant: Microsoft Technology Licensing, LLC, Redmond, WA (US)

(72) Inventors: Corneliu I. Lupu, Sammamish, WA (US); Erik V. Day, Bellevue, WA (US); David L. Hicks, Seattle, WA (US); Hemanth Kaza, Sammamish, WA (US); Justin L. Steventon, Kirkland, WA (US); Sathish Kumar Manivannan, Redmond, WA (US); Sudheer Kumar Pasula, Redmond, WA (US); Robert J. Kenny, Woodinville, WA (US)

(73) Assignee: Microsoft Technology Licensing, LLC

(21) Appl. No.: 14/876,530

(22) Filed: Oct. 6, 2015

Related U.S. Application Data
(63) Continuation of application No. 13/042,197, filed on Mar. 7, 2011.

(51) Int. Cl. G06F 11/07; G06F 17/30; G06Q 30/06; H04L 12/24

(52) U.S. Cl. CPC G06F 11/079; H04L 41/0873; H04L 41/0853; H04L 41/082; G06F 11/0706; G06F 11/0751; G06F 11/0787; G06F 17/30539; G06Q 30/0609

(57) ABSTRACT

Application compatibility techniques are described. In one or more implementations, one or more computing devices of a service provider receive data from a plurality of client devices via a network, the data describing one or more attempts that were at least partially successful in resolving one or more incompatibilities in execution of one or more applications on respective computing devices. The data is mined based on one or more criteria to identify at least one of the applications and validated to confirm the at least partial success in the resolution of at least one of the incompatibilities for the identified application. Data is stored that describes validated successful resolution of the incompatibilities and an update is disseminated based at least on the stored data to resolve the incompatibilities.

### CROSS-REFERENCE TO RELATED APPLICATION

This patent claims priority to U.S. patent application Ser. No. 13/042,197, filed Mar. 7, 2011, and entitled “Application Compatibility Leveraging Successful Resolution of Issues,” the entirety of which application is incorporated herein by reference.

### BACKGROUND

The number of applications that are available to users is ever increasing. For example, applications were traditionally provided on a computer-readable storage medium that was purchased by a user at a bricks-and-mortar store. Therefore, a user typically traveled to the store to select from hundreds of applications that may be installed on the user's computing device.

With the advent of online application marketplaces, however, a user may have access to tens of thousands of applications that may be executed on the user's computing device. Because of the vast amount of options, however, techniques that were originally applied to ensure compatibility of the hundreds of applications may become overwhelmed when confronted with tens of thousands of applications.

### SUMMARY

Application compatibility techniques are described. In one or more implementations, one or more computing devices of a service provider receive data from a plurality of client devices via a network, the data describing one or more attempts that were at least partially successful in resolving one or more incompatibilities in execution of one or more applications on respective computing devices. The data is mined based on one or more criteria to identify at least one of the applications and validated to confirm the at least partial success in the resolution of at least one of the incompatibilities for the identified application. Data is stored that describes validated successful resolution of the incompatibilities and an update is disseminated based at least on the stored data to resolve the incompatibilities.

In one or more implementations, a user interface is output by a client device that is configured to act as guide in an attempt to at least partially resolve an incompatibility in execution of an application on the client device. Responsive to a determination by the client device that the attempt was at least partially successful in resolving the incompatibility, data is communicated that describes the attempt by the client device for receipt by a service provider via a network.

In one or more implementations, one or more computing devices have one or more modules at least partially implemented in hardware and configured to perform operations that include receiving data from a plurality of client devices via a network, the data describing one or more attempts that were at least partially successful in resolving one or more incompatibilities in execution of one or more applications on respective client devices. The modules are further configured to identify at least one application from the received data, purchase the identified application from an application marketplace that is accessible via the network, the purchase performed automatically and without user intervention, validate the at least partial success in the resolution of at least one of the incompatibilities for the purchased application, and store data that describes validated successful resolution of the incompatibilities.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform application compatibility techniques.

FIG. 2 is an illustration of a system in an example implementation in which a compatibility validation module of a service provider of FIG. 1 is utilized to compute a confidence score for a fix to a compatibility issue.

FIG. 3 is a flow diagram depicting a procedure in an example implementation in which a user interface is output by a compatibility module to resolve in an incompatibility.

FIG. 4 is a flow diagram depicting a procedure in an example implementation in which a fix is validated from data received from one or more client devices of FIG. 3 and disseminated to other client devices.

### DETAILED DESCRIPTION

### Overview

Computing devices may execute a wide variety of applications from a wide variety of different sources. For example, a user may navigate to an application marketplace via a network to access hundreds and even thousands of applications. Because of the vast amount of applications that are available, however, it may be difficult to maintain compatibility with the applications using conventional techniques, especially when newer versions of the software are provided for execution.

Application compatibility techniques are described. In one or more implementations, a compatibility module is configured to output a user interface to help guide a user toward a fix for a compatibility problem. If the fix is successful, data that describes the fix may be communicated to a service provider via a network for dissemination to other users. In this way, an initial subset of users may be leveraged to correct compatibility issues for a larger group. In one or more implementations, the service provider may identify which fixes are to be disseminated and validate that the fixes work. This may be performed by automatically purchasing the applications from an application marketplace and applying the fix described in the information to determine whether it is successful. Further discussion of the application compatibility techniques may be found in relation to the following sections.

In the following discussion, an example environment is first described that may be leveraged according to techniques described herein. Example procedures are then described which may also be employed in the example environment as well as other environments. Accordingly, performance of the example procedures is not limited to the example environment and the example environment is not limited to performing the example procedures.

### Example Environment

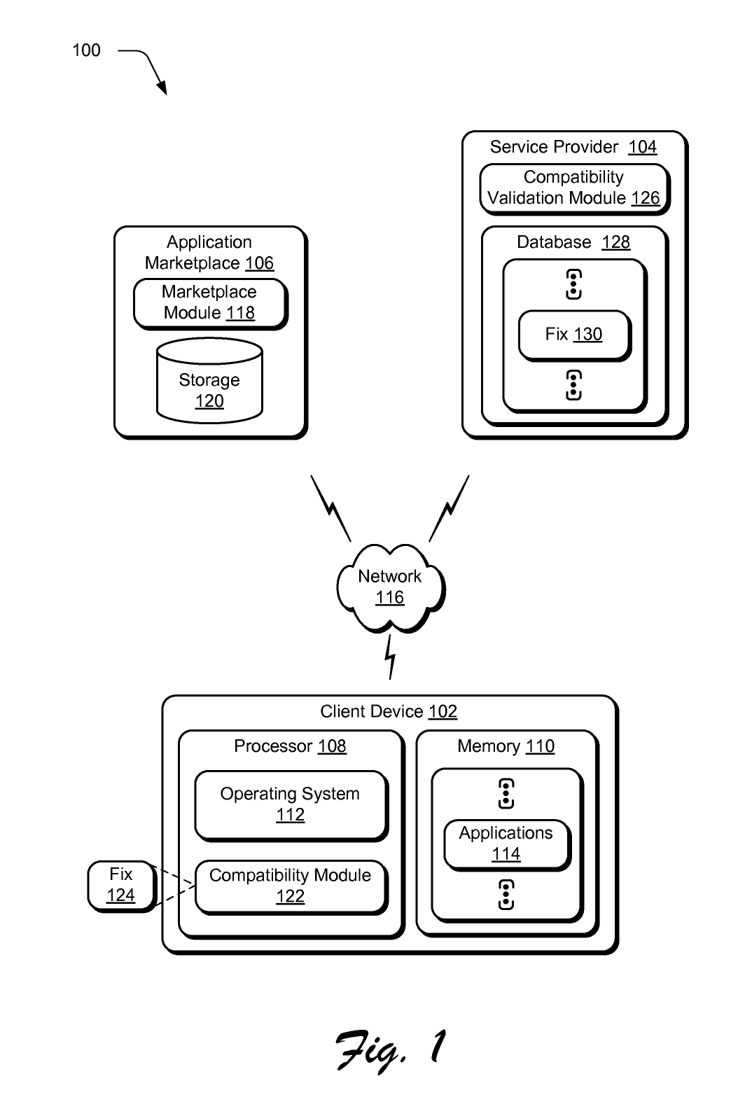

FIG. 1 is an illustration of an environment 100 in an example implementation that is operable to employ techniques described herein. The illustrated environment 100 includes a client device 102, a service provider 104, and an application marketplace 106. The client device 102, service provider 104, and application marketplace 106 may be implemented using a wide range of computing devices, which may be configured in a variety of ways. For example, a computing device may be configured as portable game device, mobile phone, a computer that is capable of communicating over a network (e.g., a desktop computer, one or more servers, an entertainment appliance), a set-top box communicatively coupled to a display device, and so forth. Thus, the computing device may range from full resource devices with substantial memory and processor resources (e.g., personal computers, game consoles) to a low-resource device with limited memory and/or processing resources (e.g., traditional set-top boxes, hand-held game consoles). Additionally, although single entities may be shown in the corresponding illustrations, it should be readily apparent that the entities may be representative of one or more entities and therefore may be referenced accordingly, e.g., a client device 102, client device 104, and so on.

A computing device may also include an entity (e.g., software) that causes hardware of the computing device to perform operations, e.g., processors, functional blocks, and so on. For example, the computing device may include a computer-readable medium that may be configured to maintain instructions that cause the computing device, and more particularly hardware of the computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

The client device 102 is the illustrated example is shown as including a processor 108 and memory 110. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single processor 104 and memory 106 are shown, a wide variety of types and combinations of memory and/or processors may be employed.

The client device 102 is illustrated as also including an operating system 112. The operating system 112 is typically employed to abstract functionality of underlying devices such as the processor 108, memory 110, and other devices to applications 114 and other software that are executed by the client device 102. Although the operating system 112 is illustrated as being executed on the processor 108, this module is also storable in memory 110.

As previously described, the application 114 may be obtained from a variety of sources. For example, applications 114 may be installed on the client device 102 using a computer-readable storage medium obtained from a brick-and-mortar store. In another example, the applications 114 may be obtained via a network 116 from the application marketplace 106. The application marketplace 106 is illustrated as including a marketplace module 118 that is representative of functionality to manage and communicate applications from storage 120 of the application marketplace 106. For example, the marketplace module 118 may employ revenue techniques (e.g., advertising, fee per download) to collect revenue for providing applications for execution by client devices 102. Therefore, a user may access the application marketplace 106 via the network 116 to access a multitude of different applications, e.g., for a fee, free, subscription basis, and so on.

To maintain compatibility, the client device 102 is further illustrated as employing a compatibility module 122, which is illustrated as being executed on the processor 108 and is storable in memory 110. The compatibility module 122 may help promote compatibility in a variety of ways. For example, the compatibility module 122 may function as a compatibility layer that is executed to automatically monitor execution of applications 114 (including the operating system 112) by the client device 102. The compatibility module 112, for instance, may monitor for known compatibility issues and output a user interface that may help guide a user towards a fix 124 that at least partially resolves the issue. In another example, the compatibility module 112 may be implemented as a troubleshooter that is executed responsive to a request received from a user. Likewise, when in this configuration the troubleshooter may output a user interface that is configured to help guide a user toward a fix 124. For example, the compatibility module 122 may apply techniques to correct a defect in the applications 114, compatibility of the application 114 with a newer version of the operating system 112, and so on.

In one or more implementations, if the fix 124 is deemed to be at least partially successful, the compatibility module 122 communicates data that describes the fix 124 via the network 116 to the service provider 104. The service provider 104 as illustrated includes a compatibility validation module 126 that is representative of functionality to validate the fix 124, e.g., that the fix “worked” as described. The compatibility validation module 126 may thus maintain a database 128 of fixes 130 that may be provided to other client devices. In this way, even though an initial subset of client devices 102 may have a less than desirable experience with an application 114 (e.g., due to the application 114 itself, changes made to an operating system 112, and so on), this experience may be leveraged for a group such that the experience is not repeated by automatically applying a corresponding fix.

Generally, any of the functions described herein can be implemented using software, firmware, hardware (e.g., fixed logic circuitry), manual processing, or a combination of these implementations. The terms “module,” “engine,” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

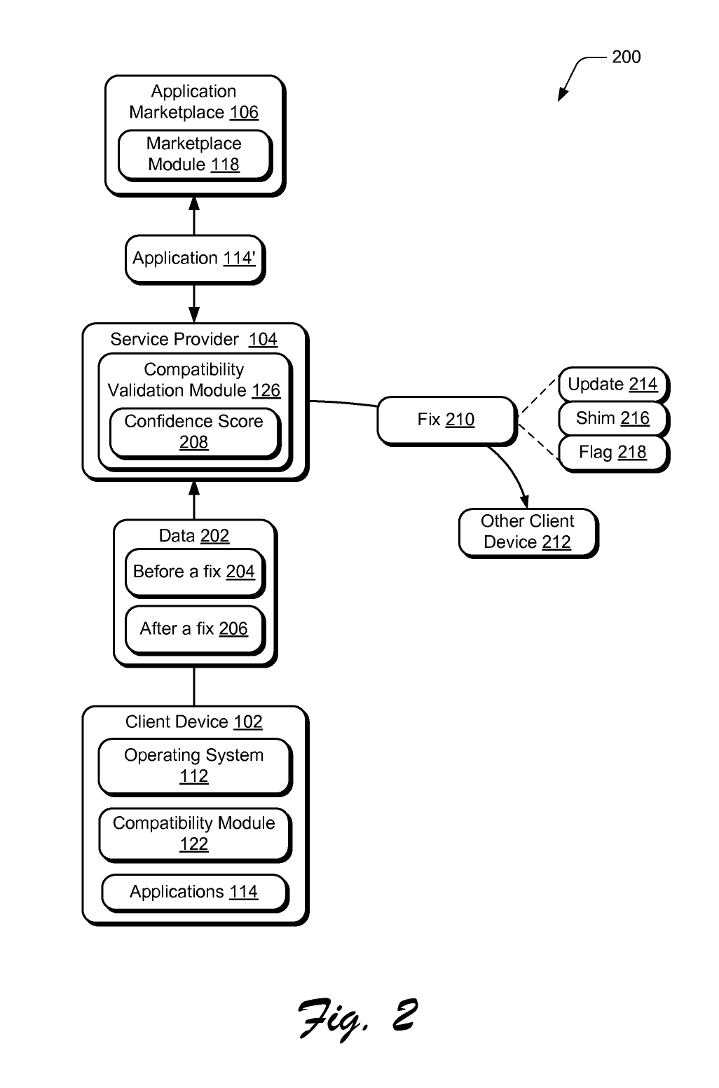

FIG. 2 is an illustration of a system 200 in an example implementation in which the compatibility validation module 126 of the service provider 104 is utilized to compute a confidence score for a fix to a compatibility issue. As before, the client device 102 includes an operating system 112, applications 114, and a compatibility module 122. The compatibility module 122 may be utilized to resolve a variety of incompatibilities that may be caused by execution of the application 114, interaction of the application 114 with the operating system 112 (e.g., due to an update of the operating system 112), and so on.

The compatibility module 122, for instance, may output a user interface that guides a user toward a fix. During resolution of the incompatibility, the compatibility module 122 may also generate data 202 that describes execution of the application 114 before a fix 204 as well as data 202 that describes execution of the application 114 after a fix 206. If it is determined that the fix was at least partially successful in resolving the incompatibility, the data 202 may be communicated by the client device 102 to the service provider 104.

The service provider 104 may then employ the compatibility validation module 126 to validate resolution of the compatibility. For example, the compatibility validation module 126 may identify the application 114 from the data 202, such as to identify the “Top X” fixed applications. The compatibility validation module 126 may then select one of the applications 114 and purchase a copy of application 114′, such as from an application marketplace 106. The compatibility validation module 126 may then compute a confidence score 208 which indicates a likelihood that the fix 210 works to at least partially resolve the incompatibility. For example, the confidence score 208 may be based on data 202 describing operation after a fix 206, such as an amount of time the application 114 has executed with the fix applied, a number of time the application 114 has executed with the fix applied, whether the fix was subsequently removed, and so on. This information may also be leveraged to identify which applications are to be validated, e.g., the “Top X” fixed applications.

Upon validation of the fix 210, the fix 210 may be disseminated to other client devices 212. For example, the fix 210 may be provided as an update 214 to the application 114 and/or operating system 112 (e.g., as part of a service pack), as a shim 216, a flag 218 (to be used to code path selection), and so on. A shim 216, for instance may be used to promote compatibility of the operating system 112 with the application 114 in a variety of ways. A shim 216 may employ hooking such that addresses in an import address table (TAT) for one or more application programming interfaces are replaced with addresses corresponding to the shim 216. The shim 216 may also be configured to intercept callbacks, e.g., to be called upon occurrence of an event by the client device 102. In this way, the shim 216 may intercept calls made to and from the APIs that are no longer compatible and translate data associated with the call such that it is compatible. In one such example, the shim 216 may translate the data to mimic a previous version of an operating system 112 such that the applications 114 may understand commands received from the operating system 112 and/or the operating system 112 may understand commands from the applications 114. A variety of other examples are also contemplated, such as to intercept I/O request packets (IRPs) by modifying declared addresses in a dispatch table.

Thus, the shim 216 may be employed to redirect the execution of calls and other communications by wrapping them inside a shim 216. In one or more implementations, shims declare wrappers for interfaces or callbacks. If such a wrapper is applied towards a shim (e.g., at runtime), than a call to or from the application 114 to a system component is processed through the wrapper. Therefore, the shim 216 may control both inputs and outputs of an interface call and modify them to correct incompatibilities. Further discussion of generation and dissemination of fixes may be found in relation to the following procedures.

### Example Procedures

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

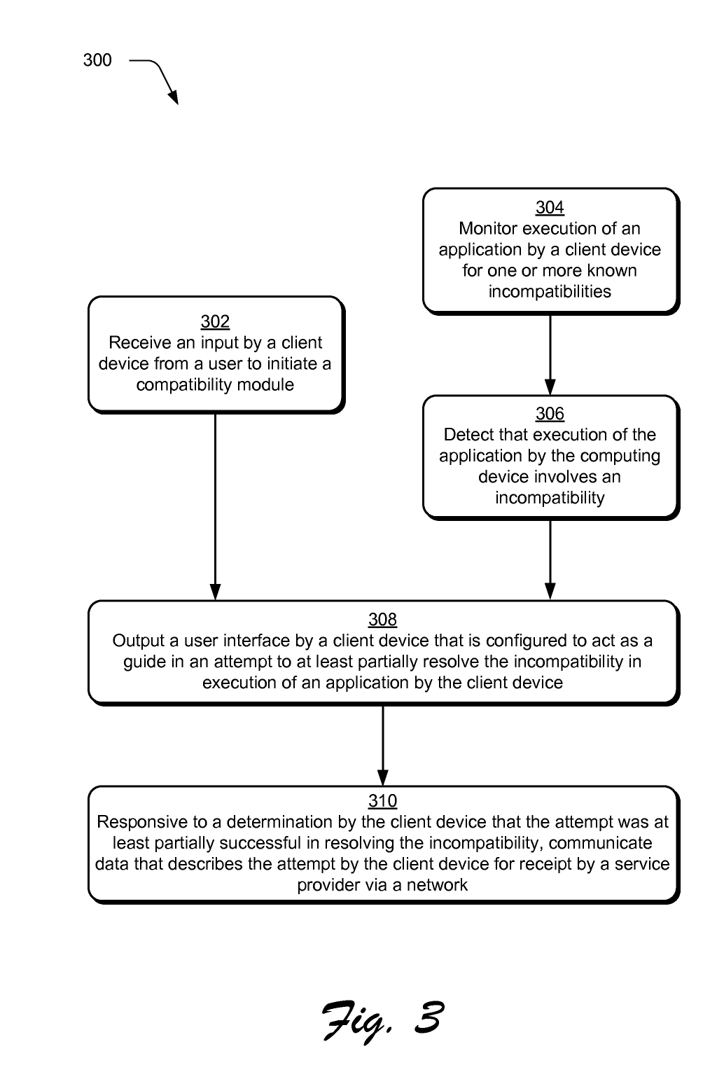

FIG. 3 depicts a procedure 300 in an example implementation in which a user interface is output by a compatibility module to resolve in an incompatibility. An input is received by a client device from a user to initiate a compatibility module (block 302). The compatibility module, for instance, may be configured as a troubleshooter that is output upon identification by a user of the client device 102 of an incompatibility. The user interface may also be output automatically and without user intervention. For example, the compatibility module may monitor execution of an application by a client device for one or more know incompatibilities (block 304). The module may then detect that execution of the application by the computing device involves an incompatibility (block 306).

A user interface is then output by a client device that is configured to act as a guide in an attempt to at least partially resolve the incompatibility in execution of an application by the client device (block 308). The user interface, for instance, may be configured as a “wizard” to guide a user through a series of steps that may be used to resolve incompatibilities. The steps may include questions that are answered by a user to follow a path that may lead to resolution of the compatibility issue.

Responsive to a determination by the client device that the attempt was at least partially successful in resolving the incompatibility, data is communicated that describes the attempt by the client device for receipt by a service provider via a network (block 310). The compatibility module 122, for instance, may monitor execution of the application 114 after the fix is applied. This monitoring may then serve as a basis for determining whether the fix was likely successful, such as based on an amount of time the application is executed with the fix applied, whether the compatibility module 122 was executed again to correct the fix, a number of times the application 114 is executed, and so on. Although use of the fix by the application 114 was described, the fix may also be applied to an operating system 112 or other software of the client device 102 (e.g., drivers), further discussion of which may be found in relation to the following figure.

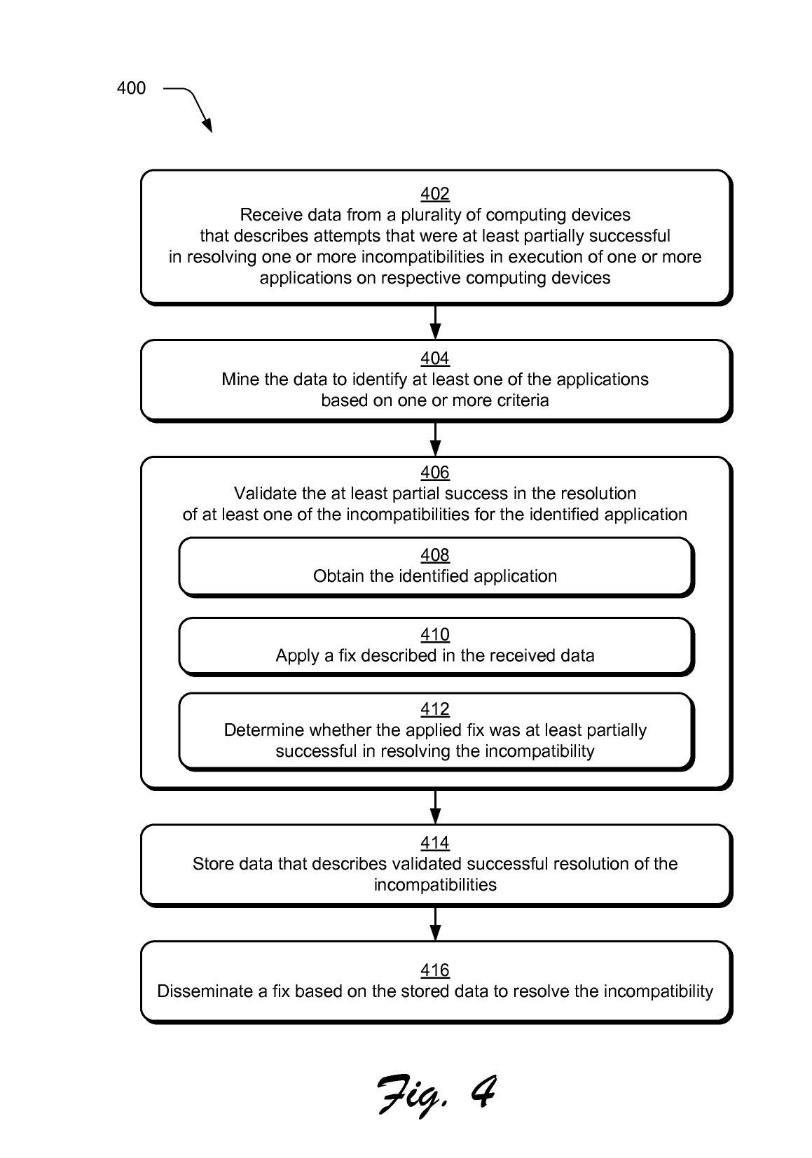

FIG. 4 depicts a procedure 400 in an example implementation in which a fix is validated from data received from one or more client devices and disseminated to other client devices. Data is received from a plurality of computing devices that describes attempts that were at least partially successful in resolving one or more incompatibilities in execution of one or more applications on respective computing devices (block 402). As described above, for instance, the compatibility module 122 may send data once it is determined that the fix was at least partially successful, thereby reducing an amount of data to be communicated to and processed by the service provider 104. For example, the amount of data may be such that sampling is not utilized as compared with conventional techniques that involve sending a log file regardless of outcome. Other implementations are also contemplated, however, such as to send data describing unsuccessful attempts.

The data is mined to identify at least one or more of the applications based on one or more criteria (block 404). The compatibility validation module 126, for instance, may compare and aggregate data from the plurality of client devices using a variety of criteria. For example, the aggregation and comparison may be used to locate fixes that were applied by a group of client devices, for fixes that were partially successful in resolving incompatibility issues, fixes that involve popular applications 114, fixes to particularly egregious compatibility issues, and so on.

The at least partial success in the resolution of at least one of the incompatibilities is validated for the identified application (block 406). For example, the identified application may be obtained (block 408), such as a copy from storage, purchased from an application marketplace, and so on. A determination may then be made as to whether the applied fix was at least partially successful in resolving the incompatibility (block 412). These steps may be performed automatically and without user intervention by the compatibility validation module 126, thereby automating the process. Naturally, other examples are also contemplated, such as output of a user interface having options to obtain the application, apply the fixes, and so on.

Data is stored that describes validated successful resolution of the incompatibilities (block 414). A fix is then disseminated based on the stored data to resolve the incompatibility (block 416). The fix, for instance, may be configured as an update (e.g., as part of a service pack), a shim, a flag used for code path selection to configure the application 114 and/or operating system 112 for compatibility, and so on. In this way, fixes applied by a small subset of users that have a less than desirable experience with an application 114 may be disseminated such that other users do not have a similar experience.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1-20. (canceled)

21. A method performed by one or more computing devices of a service provider, the method comprising:
receiving data from a plurality of client devices via a network, the data describing one or more attempts that were at least partially successful in resolving one or more incompatibilities in execution of one or more applications on respective computing devices;
identifying at least one of the applications based, at least in part, on one or more criteria;
validating the at least partial success in the resolution of at least one of the incompatibilities for the identified application; and
storing data that describes validated successful resolution of the incompatibilities; and
disseminating an update based at least on the stored data to resolve the incompatibilities, wherein the update is a shim that is configured to translate data received by the identified application and translate data sent from the identified application.

22. The method of claim 21, wherein the shim is configured to translate data received by the identified application and translate data sent from the identified application based on an import address table, the table defining one or more application programming interfaces and addresses corresponding to the shim.

23. The method of claim 21, wherein the shim is configured to intercept callbacks of an event by a client device of the plurality of client devices.

24. The method of claim 23, wherein at least one callback of the callbacks is translated to a compatible callback based, at least in part, on the stored data that describes validated successful resolution of the incompatibilities.

25. The method as described in claim 23, wherein at least one callback of the callbacks includes request packets, wherein the shim is configured to translate data by modifying declared addresses in a dispatch table.

26. The method as described in claim 21, wherein the shim declares at least one wrapper for interfaces or callbacks, wherein a callback to or from the identified application to a system component is processed through at the least one wrapper.

27. The method as described in claim 21, wherein the one or more criteria are usable to compute a confidence score that is indicative of a likelihood of success of the attempt.

28. A computing device, comprising:
a processor; and
a memory having computer-executable instructions stored thereupon which, when executed by the processor, cause the computing device to
receive data from a plurality of client devices via a network, the data describing one or more attempts that were at least partially successful in resolving one or more incompatibilities in execution of one or more applications on respective computing devices;
identify at least one of the applications based, at least in part, on one or more criteria;
validate the at least partial success in the resolution of at least one of the incompatibilities for the identified application; and
store data that describes validated successful resolution of the incompatibilities; and
disseminate an update based at least on the stored data to resolve the incompatibilities, wherein the update comprises a flag configured for code path selection or the update comprises a shim that is configured to translate data received by the identified application and translate data sent from the identified application.

29. The computing device of claim 28, wherein the shim is configured to translate data received by the identified application and translate data sent from the identified application based on an import address table, the table defining one or more application programming interfaces and addresses corresponding to the shim.

30. The computing device of claim 28, wherein the shim is configured to intercept callbacks of an event by a client device of the plurality of client devices.

31. The computing device of claim 30, wherein at least one callback of the callbacks is translated to a compatible callback based, at least in part, on the stored data that describes validated successful resolution of the incompatibilities.

32. The computing device of claim 30, wherein at least one callback of the callbacks includes request packets, wherein the shim is configured to translate data by modifying declared addresses in a dispatch table.

33. The computing device of claim 28, wherein the shim declares at least one wrapper for interfaces or callbacks, wherein a callback to or from the identified application to a system component is processed through at the least one wrapper.

34. The computing device of claim 28, wherein the flag is configured to cause a configuration of the one or more applications to correct the one or more incompatibilities based, at least in part, on the stored data that describes validated successful resolution of the incompatibilities.

35. A computer storage medium having computer-executable instructions stored thereupon which, when executed by a computing device, cause the computing device to:
receive data from a plurality of client devices via a network, the data describing one or more attempts that were at least partially successful in resolving one or more incompatibilities in execution of one or more applications on respective computing devices;
identify at least one of the applications based, at least in part, on one or more criteria;
validate the at least partial success in the resolution of at least one of the incompatibilities for the identified application; and
store data that describes validated successful resolution of the incompatibilities; and
disseminate an update based at least on the stored data to resolve the incompatibilities, wherein the update comprises a flag configured for code path selection or the update comprises a shim that is configured to translate data received by the identified application and translate data sent from the identified application.

36. The computer storage medium of claim 35, wherein the shim is configured to translate data received by the identified application and translate data sent from the identified application based on an import address table, the table defining one or more application programming interfaces and addresses corresponding to the shim.

37. The computer storage medium of claim 35, wherein the shim is configured to intercept callbacks of an event by a client device of the plurality of client devices.

38. The computer storage medium of claim 37, wherein at least one callback of the callbacks is translated to a compatible callback based, at least in part, on the stored data that describes validated successful resolution of the incompatibilities.

39. The computer storage medium of claim 37, wherein at least one callback of the callbacks includes request packets, wherein the shim is configured to translate data by modifying declared addresses in a dispatch table.

40. The computer storage medium of claim 35, wherein the flag is configured to cause a configuration of the one or more applications to correct the one or more incompatibilities based, at least in part, on the stored data that describes validated successful resolution of the incompatibilities.
